(19) United States
(12) Patent Application Publication
(10) Pub. No.: US 2005/0250951 A1
(43) Pub. Date: Nov. 10, 2005

(54) Chiral C2-symmetric biphenyls, their preparation and also metal complexes in which these ligands are present and their use as catalysts in chirogenic syntheses

(75) Inventors: Christian Peschko, Munchen (DE); Joergen Stohrer, Pullach (DE); Alfred Popp, Unterhaching (DE)

Correspondence Address: BROOKS KUSHMAN P.C., 1000 TOWN CENTER, TWENTY-SECOND FLOOR, SOUTHFIELD, MI, 48075, US

(73) Assignee: Consortium fur elektrochemische Industrie GmbH, Munich (DE)

(21) Appl. No.: 11/117,870

(22) Filed: Apr. 29, 2005

(30) Foreign Application Priority Data
May 6, 2004 (DE) 10 2004 022 397.1

(51) Int. Cl. C07F 9/28

(52) U.S. Cl. 549/218

(57) ABSTRACT

A new class of C₂-symmetric biaryldiphosphines comprising a fused ring system (dioxacycle) which has at least seven ring atoms and can be varied synthetically. The biaryldiphosphines can be used as ligands for preparing metal complexes useful as catalysts in organic synthesis, and the dioxacycles can be varied to optimize reaction with specific substrates.

### BACKGROUND OF THE INVENTION

1. Field of the Invention

The invention relates to a new class of C₂-symmetric biaryldiphosphines, their use as ligands for preparing metal complexes, metal complexes in which these ligands are present, the use of these metal complexes as catalysts in organic synthesis, and catalytic processes using these metal complexes. The present invention relates in particular to new racemic, enantiomerically pure or enantiomerically enriched biaryldiphosphines (1,1′-bis-2,2′-phosphines) which are used as bidentate ligands in the preparation of metal complexes, and the use of these metal complexes as catalysts in asymmetric reactions (chirogenic syntheses).

2. Background Art

Enantiomerically pure derivatives serve as starting materials or intermediates in the synthesis of agrochemicals and pharmaceuticals. Many of these compounds are at present prepared and marketed as a racemic mixture (“racemate”) or as a mixture of diastereomers. In many cases, however, the desired physiological effect is produced only by one enantiomer or diastereomer. The other isomer is in the best case inactive, but it can also counteract the desired effect or even be toxic. Methods of separating racemates or mixtures of diastereomers are therefore becoming ever more important for the preparation of highly enantiomerically pure compounds.

As an alternative, a stereogenic center can be produced in a targeted fashion in the molecule. This is referred to as a stereoselective synthesis, and the principle of such reactions is based on the fact that the two possible enantiomers of a chiral product are formed in unequal amounts. In enantioselective or asymmetric syntheses, optically pure or enantiomerically enriched products are obtained directly in the preparation with the aid of chiral catalysts and the optical induction effected thereby, without subsequent resolution of the racemate being necessary.

One group of chiral catalysts used in the prior art comprises a metallic center to which chiral ligands are coordinated.

A particularly important role is played by axial chirality which occurs in molecules of the point groups Cₙ and Dₙ, with the dissymmetric binaphthyl or biphenyl ligands and their metal complexes being used particularly frequently.

Binaphthyl or biphenyl systems comprise two linked naphthalene or phenyl units. In stereoselective synthesis, 2,2′-substituted 1,1′-binaphthyls or -biphenyls are widely used as ligands of metals. The C₂-axially symmetric binaphthyl skeleton in particular is an ideal chirality inducer. As coordinating substituents in the 2,2′ positions, particular mention may be made of phosphine groups.

A chiral catalyst should, particularly for industrial use, ideally have the following properties:
high productivity (S/C)
high activity (TOF)
high selectivity (ee)
inexpensive and uncomplicated synthesis of the catalyst

For industrial use, the S/C ratio (molar ratio of substrate/catalyst) should be in the range 1000 to 50,000 and the activity should be in the range 500 h⁻¹ to 1000 h⁻¹ (Blaser, H.-U. and Studer, M., Chirality 11, 459-464 (1999)). The enantiomeric excess (ee) should be >98% ee for pharmaceutical applications.

The prior art discloses a series of C₂-axially symmetric bisphosphine ligands which are used for preparing metal complexes which are in turn used as catalysts in (asymmetric) hydrogenation, carbonylation, hydrosilylation or C—C bond formation.

Substituted C₂-axially symmetric biaryl derivatives which are coordinated to a transition metal such as ruthenium, rhodium, iridium or palladium are particularly suitable as catalysts in asymmetric reactions. Mention may be made of, for example, 2,2′-bisdiphenylphosphino[1,1′]binaphthyl (BINAP) [EP 174057B1, EP245959B1, EP295109B1, EP295890B1, EP 339764 B1], 2,2′-bis(diphenylphosphine)-3,3′-dibenzo[b]thiophene (BITIANP) [EP 770085 B1], 5,5′-bisdiphenylphosphino[4,4′]bi[benzo[1,3]dioxolyl] (SEGPHOS) [EP 850945 B1], 6,6′-bisdiphenylphosphino-2,3,2′,3′-tetrahydro[5,5′]bi[benzo[1,4]dioxinyl] (SYNPHOS) [WO 03/029259 A1] or (bis-4,4′-dibenzofuran-3,3′-diyl)bis(diphenylphosphine) [EP 643065].

Numerous ligand systems for preparing chiral metal complex catalysts which have been matched to specific requirements of particular reactions have been developed in the past on the basis of the fundamental work on BINAP. In particular, studies on the steric and electronic influences of substituents on BINAP-analogous ligand systems have been undertaken. Thus, the influences of fused-on rings of intermediate size on biaryl ligands and the influence of additionally introduced stereocenters on the chiral induction have been examined in the prior art.

Thus, for example, the high activity and enantioselectivity of the [5,5′,6,6′-bis(2R,4R-pentadioxyl)](2,2′-bis(diphenylphosphino)(1,1′)biphenyl ligands is attributed to the presence of four asymmetric carbon atoms of the 3,4-dihydro-2H-1,5-dioxepin units [Qiu, L.; Qi, J.; Pai, C.-C.; Chan, S.; Zhou, Z.; Choi, M. C. K.; Chan, A. S. C.; Organic Letters 2002, Vol. 4, No. 26, 4599-4602]. However, these systems have the disadvantage that expensive chiral reagents have to be used in their preparation and mixtures of diastereomers which firstly have to be separated in an additional step, which in turn leads to a reduction in the possible yield of pure isomers, are formed as products.

None of the catalysts known from the prior art has hitherto comprehensively met the abovementioned criteria, in particular in respect of activity, selectivity and accessibility for industrial use. A particular challenge for the ligand system is the fact that, in particular, the twisting along the C—C link of the biaryl units represents an important parameter which has an individual optimum depending on the properties of the substrate to be reacted in the particular case.

### SUMMARY OF THE INVENTION

It is therefore an object of the invention to provide an alternative ligand system which meets the requirements of a catalyst system to be used in industry and also has a wide application range in respect of substrates to be reacted. This and other objects are achieved by the provision of a new class of C₂-symmetric biaryldiphosphines comprising a fused ring system (dioxacycle) which has at least seven ring atoms and can be varied synthetically and thus matched to the individual requirements of the respective substrate to be reacted in a simple fashion, their use as ligands for preparing metal complexes and the use of these complexes as catalysts in chiral synthesis.

### DETAILED DESCRIPTION OF THE PREFERRED EMBODIMENT(S)

The invention provides compounds of the general formula (I) 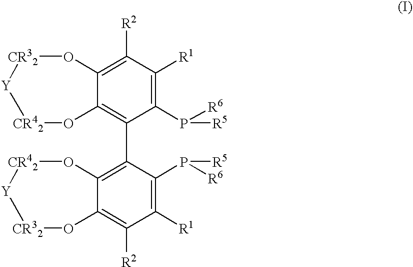
wherein
R¹ and R² are each hydrogen and
R³ and R⁴ can be identical or different and are selected independently from the group consisting of hydrogen, fluorine, C₁-C₁₀-alkyl or CF₃,
Y is a divalent radical selected from the group consisting of CR⁹₂, CHR⁹, (cis)-CH═CH, CR⁹₂CR¹⁰₂, CHR⁹CHR¹⁰, 1,2-arylene, CHR⁹—O—CHR¹⁰ or CR⁹₂—O—CR¹⁰₂,
where R⁹ and R¹⁰ can be identical or different and otherwise are selected independently from the group consisting of hydrogen; Q; monosubstituted, polysubstituted or unsubstituted C₁-C₁₀-alkyls, C₃-C₁₀-cycloalkyls, C₂-C₁₀-alkenyls, C₄-C₁₀-cycloalkenyls, C₂-C₁₀-alkynyls, C₆-C₁₅-aryls and C₁-C₁₅-heteroaryls, where the substituents may in turn have the meanings of Q and
Q is selected from the group consisting of —F, —Cl, —Br, —I, —CN, —NO₂, —NR⁷R⁸, —NR⁷OR⁸, —OR⁷, —C(O)R⁷, SR⁷, —SO₃R⁷, —C(O)OR⁷, —C(O)NR⁷R⁸, —OC(O)R⁷, —NR⁷C(O)R⁸,
R⁷ and R⁸ can be identical or different and otherwise can independently have the meanings of R⁹,
R⁵ and R⁶ can be identical or different and are selected independently from the group consisting of monosubstituted, polysubstituted or unsubstituted C₃-C₁₀-cycloalkyls, C₄-C₁₀-cycloalkenyls, C₅-C₁₅-aryls and C₁-C₁₅-heteroaryls, where the substituents may in turn have the meanings of Q.

The invention further provides for the use of the compounds of the general formula (I) as ligands for preparing complexes comprising at least one ligand of the general formula (I) and at least one metallic or semimetallic center. When the catalysts which can be obtained using the ligands of the invention are used in the synthesis of chiral compounds, it is possible to achieve high productivities, high activities and high selectivities.

Since the novel biphenyl compounds of the general formula (I) have, in contrast to the ligand systems known from Qiu et al., only one rotational axis as a chirality element, expensive chiral starting materials can be dispensed with in their synthesis and their synthesis does not result in formation of mixtures of diastereomers, whose separation makes an additional process step necessary and reduces the possible yield of pure isomers.

In contrast, the resolution of the racemates comprising pairs of enantiomers which can be obtained in the preparation of the novel ligands of the general formula (I) can be achieved without any particular outlay in terms of apparatus, for example by means of simple cocrystallization.

The twisting of the biphenyl axis can be controlled via the ring size (by variation of Y) and substitution (by variation of R³ and R⁴) of the dioxacycles and the bite angle of the ligands of the invention can thus be appropriately adjusted to meet the particular requirements. The 7- to 9-membered rings which are present on the biphenyl skeleton according to the invention produce steric hindrance in the ligand sphere as a result of their nonplanarity. Thus, in addition to the effect of axial chirality, the chiral induction is reinforced by steric influences without additional chiral centers being present in the ligand.

Preferred radicals R⁹ and R¹⁰ or R⁷ and R⁸ from the group of C₁-C₁₀-alkyls are selected from the group consisting of methyl, ethyl, n-propyl, isopropyl, n-butyl, isobutyl and tert-butyl.

Preferred radicals R⁹ and R¹⁰ or R⁷ and R⁸ from the group of C₃-C₁₀-cycloalkyls are selected from the group consisting of cyclopropyl, cyclobutyl, cyclopentyl and cyclohexyl.

Preferred radicals R⁹ and R¹⁰ or R⁷ and R⁸ from the group of C₂-C₁₀-alkenyls are selected from the group consisting of vinyl, isopropenyl and 2-methyl-2-butenyl.

Preferred radicals R⁹ and R¹⁰ or R⁷ and R⁸ from the group of C₄-C₁₀-cycloalkenyls are selected from the group consisting of cyclopent-2-enyl, cyclopent-3-enyl, cyclohex-1-enyl, cyclohex-2-enyl and cyclohex-3-enyl.

Preferred radicals R⁹ and R¹⁰ or R⁷ and R⁸ from the group of C₂-C₁₀-alkynyls are selected from the group consisting of ethynyl, 1-propynyl, 2-propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl and 5-hexynyl.

Preferred radicals R⁹ and R¹⁰ or R⁷ and R⁸ from the group of C₆-C₁₅-aryls are selected from the groups consisting of phenyl, naphthyl and anthracenyl.

Preferred radicals R⁹ and R¹⁰ or R⁷ and R⁸ from the group of C₁-C₁₅-heteroaryls are selected from the group consisting of pyrrolyl, imidazolyl, furanyl, pyridyl, pyrimidyl, pyrazolyl, indolyl, benzimidazolyl, benzofuranyl, oxazolyl, thiophenyl, thiazolyl and benzothiazolyl.

Preferred radicals Q are selected from the group consisting of —F, —Cl, —Br, —I, —CN, —NO₂, N(Me)₂, N(Et)₂, N(Pr)₂, N(iso-Pr)₂, NHOMe, N(Me)OMe, N(Et)OEt, N(Me)OEt, OMe, OEt, Oiso-Pr, OBn, C(O)Me, C(O)Et, C(O)CF₃, C(O)Ph, SMe, SEt, SPh, SBn, SO₃Me, SO₃Et, SO₃Ph, C(O)OMe, C(O)OEt, C(O)OPh, C(O)OBn, C(O)N(Me)₂, C(O)N(Et)₂, C(O)NHMe, C(O)NH₂, C(O)N(isoPr)₂, C(O)NHEt, C(O)NH(isoPr), C(O)NHMe, C(O)NH(nPr), C(O)N(nPr)₂, C(O)NHBu, C(O)N(Bu)₂, C(O)NHBn, OC(O)Me, OC(O)Et, OC(O)CF₃, OC(O)Ph, NHC(O)Me, NHC(O)Et, NHC(O)CF₃, NMeC(O)Me, NMeC(O)Et and NHC(O)Ph, in particular F, Cl, CN, NO₂, NMe₂, NEt₂, NHOMe, OMe, OEt, Oiso-Pr, OBn, C(O)Me, C(O)CF₃, SMe, C(O)OMe, C(O)N(Me)₂, C(O)NHMe, OC(O)Me, OC(O)CF₃, NHC(O)Me and NHC(O)CF₃.

The radicals R⁵ and R⁶ are each preferably phenyl or cyclohexyl substituted by Q or unsubstituted phenyl or cyclohexyl. In a particularly preferred embodiment of the novel ligands of the general formula (I), the radicals R⁵ and R⁶ are identical and are selected from among the abovementioned preferred embodiments.

Particular preference is given to R⁵ and R⁶ each being a phenyl substituent.

Furthermore, the radicals R⁹ and R¹⁰ are preferably selected from the group consisting of hydrogen, methyl, ethyl, propyl, fluorine and CF₃. In a particularly preferred embodiment of the novel ligands of the general formula (I), the radicals R⁹ and R₁₀ are identical and are selected from among the abovementioned preferred embodiments.

In an alternative embodiment in which Y is CR⁹₂, Y forms a spiro substituent, with C being a quaternary carbon atom and R⁹ being selected from the group consisting of (CH₂)₂, (CH₂)₃ and (CH₂)₄.

In typical embodiments of the ligands of the invention, R³═R⁴═H, with Y being selected from the group consisting of CH₂, (CH₂)₂, C(CH₃)₂, 1,2-arylene, CH═CH, CH₂OCH₂ and (CF₂)₂. An alternative possibility is R³═R⁴═F, with Y being (CF₂)₂, or R³═R⁴═CH₃, with Y being (CH₂)₂.

Specific possible embodiments of novel compounds or ligands of the general formula (I) are shown below.

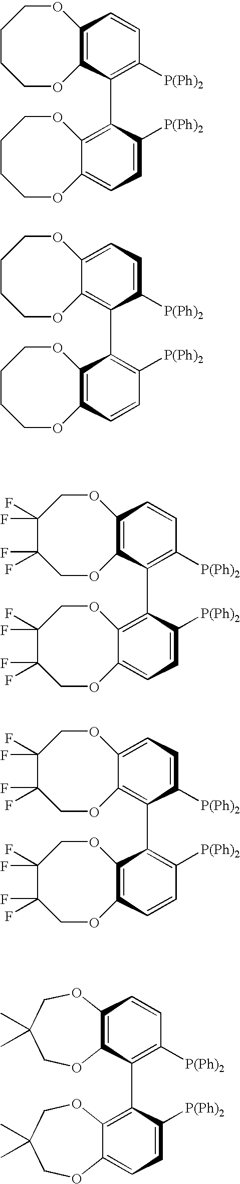

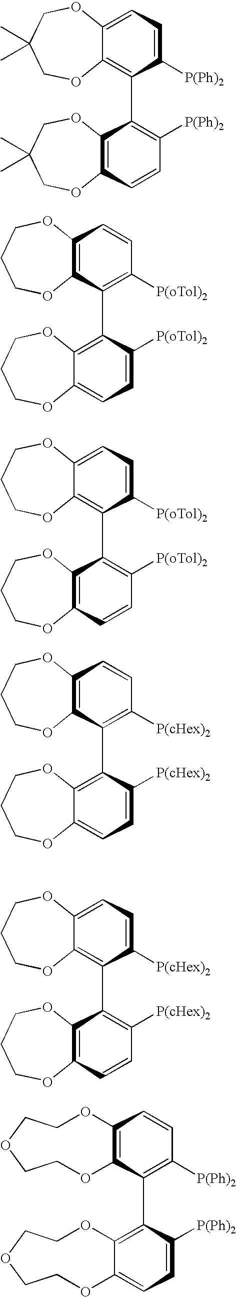

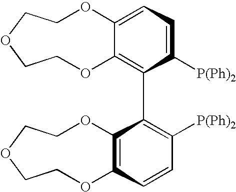

A particularly preferred embodiment of the novel compounds or ligands of the general formula (I) comprises (S)-(−)-[6,6′-bis(3,4-dihydro-2H-1,5-benzodioxepin)-7,7′-diyl]bis(diphenylphosphine) (VIIa) 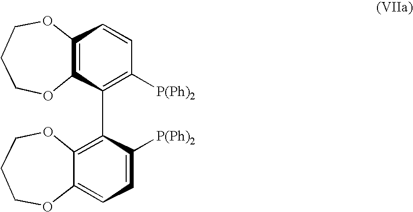
and (R)-(+)-[6,6′-bis(3,4-dihydro-2H-1,5-benzodioxepin)-7,7′-diyl]bis(diphenylphosphine) (VIIb)

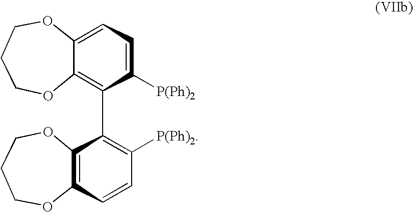

The preparation of the compounds of the invention can easily be carried out by means of reaction steps known to those skilled in the art using the process steps shown in scheme 1. A synthetic principle for compounds of the general formula (I) which can be applied to specific individual cases is illustrated, in particular, in the examples.

A general synthetic principle for ligands of the biaryldiphosphine type is known to those skilled in the art, in particular from Genêt, J.-P. et al. Organic Process Research & Development, 2003, 7, pp. 399-406, and Saito, T. et al. Adv. Synth. Catal. 2001, 345(3), pp. 264-267.

The Arabic numerals next to the reaction arrows in scheme 1 refer to the process steps described in detail below:

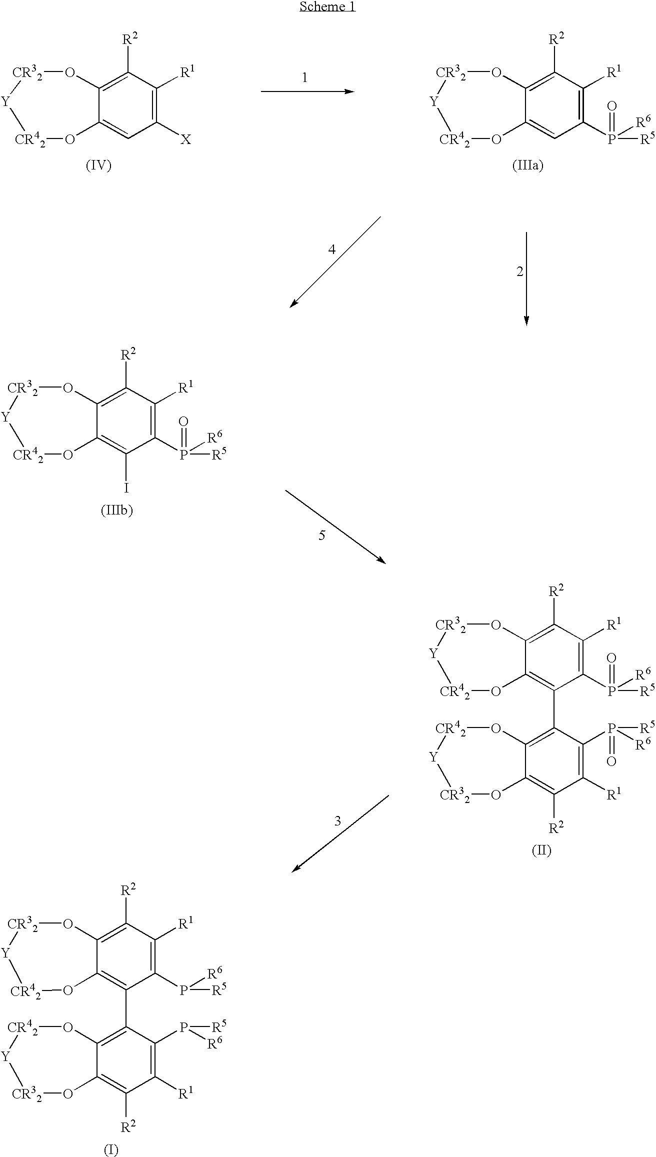

The novel compounds of the general formula (I) and also the compounds of the general formula (II) can be prepared in enantiomerically pure, enantiomerically enriched or racemic form.

The compounds of the formula (I) can be obtained in their optically enriched forms (R) or (S) or in their racemic forms by reduction of compounds of the formula (II) (3, scheme 1), 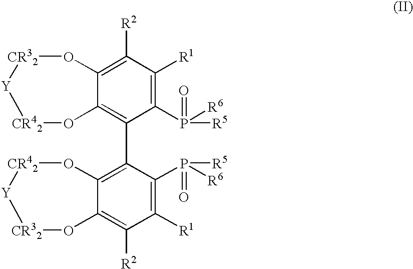
where R¹ to R⁶ in compounds of the general formula (II) have the meanings given above for the compounds of the general formula (I), and (I) and (II) can be an optically pure or optically enriched (R) or (S) form or the racemic form (Ia, Ib or IIa or IIb).

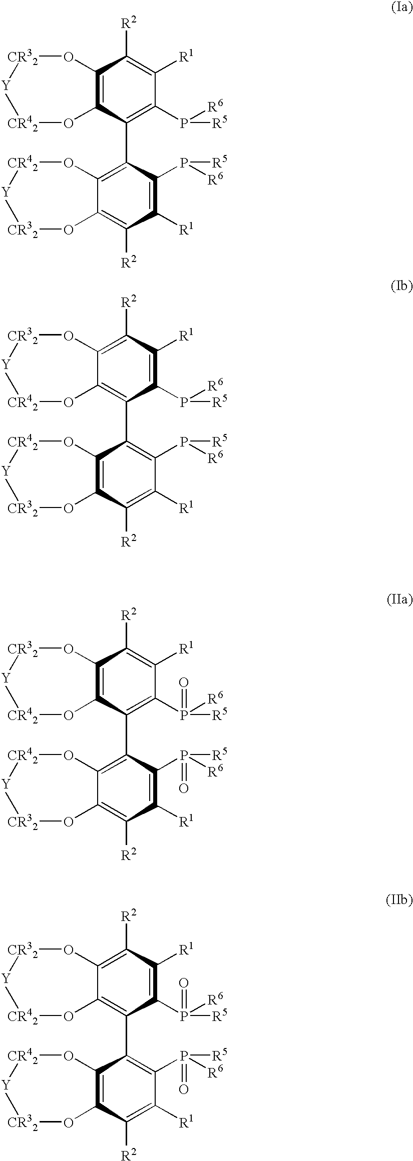

The compounds of the formula (II), which in racemic, enantiomerically pure or enantiomerically enriched form represent intermediates, are likewise subject matter of the present invention, where R¹ to R¹⁰, Y and Q have the meanings given above for the compounds of the general formula (I) and in particular correspond to the abovementioned preferred embodiments.

The reduction is, in one possible embodiment, carried out by action of a reducing substance, preferably trichlorosilane, in the presence of an amine, preferably dimethylaniline (3, scheme 1). The generalized principle is illustrated in Example 4.

The compounds of the formula (II) are obtained in enantiomerically pure or enantiomerically enriched form by, for example, resolution of racemic (II) by crystallization in the presence of complexing chiral compounds. A preferred procedure is complex formation with chiral acids by fractional crystallization, in particular with (−)-L-dibenzoyltartaric acid or (+)-D-dibenzoyltartaric acid, which appear suitable to a person skilled in the art from the prior art, in particular from Noyori, R. et al. in J. Org. Chem. 1986, 51, 629ff, for this type of racemate resolution. A generalized procedure is illustrated in Example 3.

As an alternative, the enantiomers can, for example, be obtained by chromatographic separation.

As an alternative, the enantiomers can also be separated via compounds of the general formula (I), in particular via chiral Pd complexes, as is known to those skilled in the art from Noyori, R. et al. in J. Am. Chem. Soc. 1980, 102, p. 7932ff.

The compounds of the formula (II) can in turn be prepared from compounds of the general formula (IIIa), 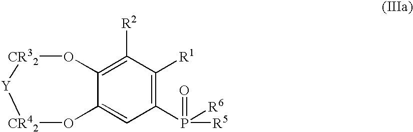
where R¹ to R¹⁰, Y and Q have the meanings indicated above for the compounds of the general formula (I), for example by means of oxidative coupling, preferably by action of lithium organyls, particularly preferably lithium diisopropylamide, in the presence of a suitable oxidant, preferably iron(III) chloride (2, scheme 1). A generalized synthetic method is illustrated in Example 2.

As an alternative, the compounds of the formula (II) can likewise be prepared from derivatives (IIIa) in two steps (4/5, scheme 1):
a) iodation of the compound (IIIa), preferably by deprotonation with lithium diisopropylamide and subsequent reaction with 1,2-diiodoethane, to form iodide derivatives of the formula (IIIb) (4, scheme 1), 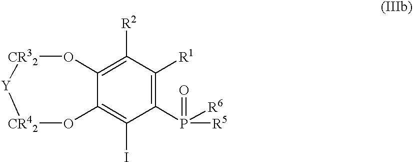
b) followed by a metal-catalyzed coupling reaction, preferably a copper-catalyzed coupling reaction (5, scheme 1), to form compounds of the formula (II).

The compounds (IIIa) can be prepared from compounds of the general formula (IV), where X is halogen, preferably bromine, and R¹ to R⁴ have the meanings given above for the compounds of the general formula (I), preferably via the corresponding Grignard species and subsequent reaction with a phosphinyl chloride R⁵R⁶P(O)Cl, where R⁵ and R⁶ have the meanings given above for (I) (1, scheme 1).

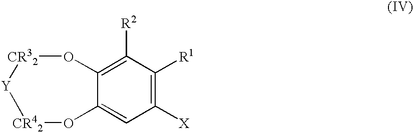

The invention further provides the synthetically valuable intermediates for preparing the compounds of the general formula (I).

Thus, the invention further provides compounds of the general formula (IIIa) or (IIIb) 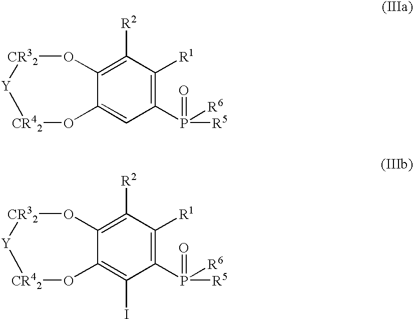
where R¹ to R¹⁰, Y and Q have the meanings given above for the compounds of the general formula (I) and in particular correspond to the abovementioned preferred embodiments.

In preferred embodiments of compounds of the general formula (IIIa) or (IIIb), CR³₂—Y—CR⁴₂ is (CH₂)₃ and R¹═R²═H and R⁵═R⁶=Ph.

The invention further provides compounds of the general formula (IV) 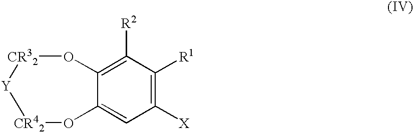
where R¹ to R⁴, R⁷ to R¹⁰, Q, X and Y are as defined above and in particular correspond to the abovementioned preferred embodiments, with the proviso that CR³₂—Y—CR⁴₂ cannot be (CH₂)₃ when X is Br (R¹ and R² are by definition hydrogen).

The compounds of the general formula (IV) as starting materials for the synthesis of the ligands of the invention are in the specific case in which CR³₂—Y—CR⁴₂ is (CH₂)₃ at the same time as X is Br (R¹ and R² are by definition hydrogen) commercially available, and the other representatives of this class of compounds can be prepared by a simple generalized synthetic sequence which is shown here for the commercially available starting material:

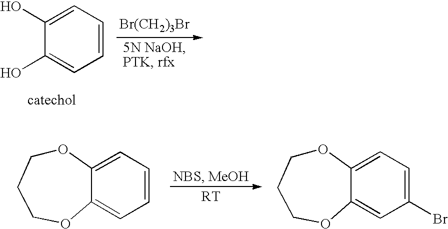

The synthetic sequence in respect of the ring system is known to those skilled in the art, in particular from Eynde, J. J. V. et al. Synthetic Communications, 2001, 31(1), pp. 1-7.

The invention further provides for the use of the compounds of the general formula (I) as ligands for preparing complexes comprising at least one ligand of the general formula (I) and at least one metallic center.

The ligands can be used in racemic, enantiomerically pure or enantiomerically enriched form and be coordinated to a metal center.

Accordingly, the invention further provides metal complexes comprising at least one ligand of the general formula (I) and at least one metallic center. Further ionic or uncharged ligands can optionally be present in addition to the ligands of the general formula (I).

The metal complexes of the invention can be used quite generally as homogeneous catalysts or in immobilized form as heterogeneous catalysts in organic synthesis.

The metallic center can generally be selected from the group consisting of uncharged or ionic main group metals and uncharged or ionic metals of the transition group elements of the PTE. As metallic centers, preference is given, in particular, to metals which, on the basis of their general chemical nature and taking account of their oxidation state, appear suitable for the formation of phosphine complexes. In particular, a person skilled in this field will choose metals which are generally regarded as typical catalyst metals for the particular type of reaction to be catalyzed.

The coordination and catalysis properties of the complexes of the invention in which the ligands of the invention are present can be set so as to meet the respective requirements by choice of the substituents on the biphenyl skeleton. Apart from the possibility of substitution of the biphenyl skeleton by rings of various sizes, with or without substituents, by means of which the coordination angle (known as “bite angle”) of the ligand in the complex can be varied, substitutions on the overall ligand and variation of the radicals R⁵ and R⁶ make it possible to match the steric and electronic properties and thus finally the coordination properties of these compounds to the necessary circumstances in a targeted manner. Thus, for example, the coordination properties of the phosphorus atoms can be set so as to meet the respective requirements by means of electron-withdrawing substituents, in particular when R³ is F, or electron-donating substituents, in particular when R⁵ and R⁶ are cyclohexyl.

In a preferred embodiment of the complexes of the invention, the compounds of the general formula (I) are used in enantiomerically enriched or, particularly preferably, enantiomerically pure form as ligand and are complexed to a metal, in particular a transition metal, to give chiral complexes.

If a compound of the general formula (I) in racemic form is used as ligand, the chirality of the metal complex can also be achieved by means of a further, chiral ligand, preferably by means of a coordinated chiral diamine. As an alternative, it is also possible for an enantiomerically pure ligand in the form of a compound of the general formula (I) and a chiral diamine as further ligand to be present at the same time.

A particularly preferred chiral diamine is (S,S)- or (R,R)-1,2-diphenylethylenediamine.

Possible embodiments of such complexes are Ru complexes with rac-VII, VIIa or VIIb in combination with (S,S)- or (R,R)-1,2-diphenylethylenediamine, in particular [Ru(rac-[6,6′-bis(3,4-dihydro-2H-1,5-benzodioxepin)-7,7′-diyl]bis(diphenylphosphine))Cl₂(S,S)-1,2-diphenylethylenediamine]=[Ru(rac-VII)Cl₂(S,S)-1,2-diphenylethylenediamine] or [Ru((R)-(+)-[6,6′-bis(3,4-dihydro-2H-1,5-benzodioxepin)-7,7′-diyl]bis(diphenylphosphine))Cl₂(S,S)-1,2-diphenylethylenediamine]=[Ru(VIIb)Cl₂(S,S)-1,2-diphenylethylenediamine].

The metal complexes of the invention can generally be used as catalysts in organic synthesis, preferably in the form of the chiral metal complexes of the invention as chiral catalysts in asymmetric organic synthesis.

In general, the catalysts are suitable for hydrogenation, isomerization and C—C bond formation reactions.

The chiral catalysts of the invention can be used for asymmetric syntheses, preferably for the asymmetric hydrogenation of unsaturated compounds, the isomerization of olefins and asymmetric C—C bond formation reactions.

The catalysts of the invention in which ligands of the general formula (I) are present are particularly preferably employed in the hydrogenation of C═O, C═C or C═N groups. The catalysts usually used for this reaction are preferably based on rhodium, ruthenium, iridium, palladium, copper or nickel.

One possible embodiment of metal complexes of the invention comprises compounds of the general formula (V)
MₘLᵣXₚS_{q} (V)
where
M is a metal selected from the group consisting of rhodium, ruthenium, iridium, palladium and nickel, and
L is a compound of the general formula (I)
and, otherwise,
X, S, m, r, p and q are defined as follows:
when M=Rh, X is Cl, Br, I; m=r=p=2; q=0;
when M=Ru, X is —OC(O)CH₃(OAc); m=r=1; p=2; q=0;
or X is Br; m=r=1; p=2; q=0;
or X is Cl; m=r=1; p=2; q=0;
or X is Cl; S═N(CH₂CH₃)₃; m=r=2; p=4; q=1;
or X is methylallyl; m=r=1; p=2; q=0;
or X is Cl; S=pyridine; m=r=1; p=q=2;
or X is Cl; S=a chiral 1,2-diamine; m=r=1; p=q=2;
or X is Cl; S=a chiral 1,2-diamine; m=r=1; p=2; q=1;
when M=Ir, X is Cl, Br or I; m=r=p=2; q=0;
when M=Pd, X is Cl; m=r=1; p=2; q=0;
or X is π-allyl; m=r=p=2; q=0;
when M═Ni, X is Cl, Br or I; m=r=1; p=2; q=0.

A further possible embodiment of the metal complexes of the invention comprises compounds of the general formula (VI)
[M_{w}LₛZₜWᵤ]Aᵥ (VI)
where
M is a metal selected from the group consisting of rhodium, ruthenium, iridium, palladium and copper, and
L is a compound of the general formula (I)
and otherwise
Z, W, A, w, s, t, u and v are defined as follows:
when M=Rh, Z is 1,5-cyclooctadiene (cod) or norbornadiene (nbd); A=BF₄, ClO₄, PF₆, OTf or BPh₄;
   w=s=t=v=1; u=0;
when M=Ru, Z is Cl, Br or I; W=benzene or p-cymeme;
   A=Cl, Br or I;
   w=s=t=u=v=1;
or A is BF₄, ClO₄, PF₆, BPh₄; w=s=1; t=u is 0; v=2;
or Z is Cl; A=NH₂(C₂H₅)₂; w=s=2; t=5; u=0; v=1;
when M=Ir, Z is cod or nbd; A=BF₄, ClO₄, PF₆ or BPh₄; w=s=v=t=1; u=0;
when M=Pd, A is BF₄, ClO₄, PF₆ or BPh₄; w=s=v=1; t=u=0;
when M=Cu, A is ClO₄, PF₆; w=s=v=1; t=u=0.

In particularly preferred embodiments of the novel complexes of the general formulae (V) and (VI), M is selected from the group consisting of rhodium, ruthenium and iridium. Furthermore, the ligand L of the general formula (I) used in such particularly preferred embodiments is in enantiomerically pure form, in particular selected from among the abovementioned particularly preferred embodiments of compounds of the general formula (I).

The complexes of the invention, in particular the abovementioned compounds of the general formulae (V) and (VI), can generally be prepared by methods which are described in the literature or are known to those skilled in the art, in particular the methods described or cited in Mashima, K. et al. J. Org. Chem. 1994, 59, pp. 3064-3076; Genêt, J.-P. et al. Tetrahedron Lett., 36(27), 1995, pp. 4801-4804; King, S. A. et al. J. Org. Chem. 1992, 57, pp. 6689-6691; Ager, D. J. et al. Tetrahedron: Asymmetry, 8(20), pp. 3327-3355, 1997.

The complexes of the invention are generally prepared from a metal complex precursor whose nature depends on the metal selected. Possible precursors are typically [Rh(cod)₂]OTf, [Rh(cod)₂]BF₄, [Rh(cod)₂]ClO₄, [Rh(cod)₂]BPh₄, [Rh(cod)₂]PF₆, [Rh(nbd)₂]OTf, [Rh(nbd)₂]BF₄, [Rh(nbd)₂]ClO₄, [Rh(nbd)₂]BPh₄, [Rh(nbd)₂]PF₆, [{Rh(cod)}₂(μ-Cl)₂], RuCl₃, [RuCl₂(benzene)]₂, [RuCl₂(cod)]ₙ, [{RuBr(p-cymene)}₂(μ-Br)₂], [{RuI(p-cymene)}₂(μ-I)₂], [{RuCl(p-cymene)}₂(μ-Cl)₂], [Ir(cod)₂]OTf, [Ir(cod)₂]BF₄, [Ir(cod)₂]ClO₄, [Ir(cod)₂BPh₄, [Ir(cod)₂]PF₆, [Ir(nbd)₂]OTf, [Ir(nbd)₂]BF₄, [Ir(nbd)₂]ClO₄, [Ir(nbd)₂]BPh₄, [Ir(nbd)₂]PF₆, [{Ir(cod)}₂(μ-Cl)₂], [Ir(cod)(CH₃CN)₂BF₄, Pd(OAc)₂, PdCl₂, PdBr₂, [PdCl₂(CH₃CN)₂], [PdCl₂(cod)], [Pd(π-allyl)Cl]₂, [Pd(methylallyl)Cl]₂, [Pd(CH₃CN)₄(BF₄)₂], NiCl₂, NiBr₂, NiI₂, Cu(acac)₂, Cu(ClO₄)₂, CuCl, CuBr or CuI.

The metal complexes of the invention are generally prepared by mixing the metal complex precursor with the ligand of the general formula (I) in a suitable, if appropriate water-free and degassed, organic solvent (cf. Examples 6 and 7). The reaction temperature can be in the range from 15 to 150° C., preferably from 30 to 120° C.

Suitable solvents are all solvents known to those skilled in the art for this reaction, in particular aromatic hydrocarbons such as benzene, toluene; amides such as dimethylformamide, N-methylpyrrolidinone; chlorinated hydrocarbons such as dichloromethane, trichloromethane; alcohols such as methanol, ethanol, n-propanol or isopropanol; ketones such as acetone, methyl ethyl ketone, cyclohexanone; ethers such as tetrahydrofuran, diethyl ether, methyl tert-butyl ether; linear, branched and cyclic alkanes such as pentane, hexane, cyclohexane, and mixtures of the abovementioned solvents.

The complexes can either be isolated by methods known to those skilled in the art or be used in situ without prior isolation.

The invention further provides for the use of the metal complexes of the invention as catalysts in organic synthesis, preferably as chiral catalysts in asymmetric reactions. These catalytic processes can be carried out in a manner known to those skilled in the art.

For example, in the case of asymmetric hydrogenation, a solution of the unsaturated substrate together with the metal catalyst is reacted in the presence of hydrogen or a hydride donor, for example an alcohol. The reaction conditions in this process are analogous to the conditions known from the literature or known by those skilled in the art (e.g.: Ager, D. J.; Laneman, S. A. in Tetrahedron: Asymmetry, Vol. 8, 20, pp. 3327-3355, 1997; and Tang, W.; Zhang, X. in Chem. Rev., 103, pp. 3029-3069, 2003, and also references cited therein).

Thus, the hydrogen pressure can be in a range from 1 to 150 bar, preferably in a range from 1 to 50 bar. The temperature can be in a range from 0 to 150° C., preferably in a range from 20 to 100° C. The molar ratio of substrate/catalyst (S/C) can be in a range from 100:1 to 250,000:1, preferably in a range from 300:1 to 20,000:1.

For the hydrogenation, further substances such as salts or acids can be added to the substrate. Preference is given to adding organic acids, their salts or inorganic acids or their salts. Particular preference is given to adding methanesulfonic acid, trifluoromethanesulfonic acid, para-toluenesulfonic acid, acetic acid, trifluoroacetic acid, hydrochloric acid, sulfuric acid or their salts.

A preferred use of the catalysts of the invention is the asymmetric hydrogenation of double bonds selected from the group consisting of C═C, C═O and C═N.

In a typical embodiment of a catalytic process according to the invention using the metal complexes of the invention containing the novel ligands of the general formula (I), a methanolic solution of methyl 3-oxopentanoate (50% by weight) is stirred in the presence of [RuCl(p-cymene)(VIIb)]Cl (0.05 mol %) and methanesulfonic acid (0.025 mol %) at 100° C. and a hydrogen pressure of 10 bar for 24 hours. After purification by distillation, methyl(R)-3-hydroxy-pentanoate can be obtained as product of the enantioselective carbonyl hydrogenation in a high optical (>98% ee) and chemical purity (>98%).

A particularly preferred use of the catalysts of the invention is the asymmetric hydrogenation of carbonyl compounds.

The novel diphosphine ligands of the general formula (I) and their metal complexes make it possible to prepare chiral compounds in high yields and in high optical purities.

The formation of the diaryl compounds of the invention is easy to carry out and does not require the use of expensive chiral reagents. Variation of the ring sizes and substituents on the biaryl skeleton makes it possible to set the torsion angle of the ligand according to the requirements of the application.

It has been able to be shown that the axially chiral diphosphine ligands of the invention are capable of achieving high enantioselectivities in asymmetric reactions without additional stereocenters having to be present in the ligand, which would significantly increase the costs of the synthesis.

The diphosphine ligands known from the prior art and their applications give a person skilled in the art no indications of the unexpectedly good performance of the diphosphine ligands of the invention, which dispense with the additional features described in Qui et al.

The following examples illustrate the present invention.

### EXAMPLE 1

### Synthesis of 3,4-dihydro-2H-1,5-benzodioxepin-7-diphenylphosphine oxide (Hereinafter Referred to as DBO)

6.05 g (248 mmol) of magnesium turnings together with 280 ml of tetrahydrofuran (THF) were placed in a 1 l three-neck flask provided with magnetic stirrer, reflux condenser, internal thermometer and dropping funnel under an argon atmosphere. While stirring, a solution of 55 g (240 mmol) of 7-bromo-3,4-dihydro-2H-1,5-benzodioxepin in 14 ml of THF was added dropwise over a period of 60 minutes and the temperature of the mixture was kept in the range 60-70° C. After stirring for 3 hours, the solution was cooled to 0° C. and 39.2 ml (205 mmol) of diphenylphosphinyl chloride were added dropwise over a period of 90 minutes, with the temperature being kept in the range from 0 to 10° C. The mixture was subsequently stirred at room temperature for 15 hours. At about 10° C., firstly 62 ml of water and then 72 ml of 1N HCl were added slowly and the mixture was subsequently stirred for 90 minutes. After dilution with 240 ml of water, the solution was extracted with methylene chloride (3×200 ml), the organic phases were combined and washed successively with 1N HCl (240 ml), saturated aqueous NaHCO₃ solution (240 ml), water (240 ml) and saturated aqueous NaCl solution (240 ml). After drying over Na₂SO₄, the solvent was removed under reduced pressure and the residue was dried at 60° C. under reduced pressure. Recrystallization from 200 ml of toluene gave 68.8 g (196 mmol) of 3,4-dihydro-2H-1,5-benzodioxepin-7-diphenylphosphine oxide as a yellowish solid.

Melting point: 147-149° C.

1H-NMR (CDCl₃, 500 MHz), δ=2.21 (m, 2H), 4.22 (t, 2H), 4.29 (t, 2H), 7.02 (s, 1H), 7.17-7.28 (m, 2H), 7.42-7.49 (m, 4H), 7.53 (t, 2H), 7.67 ppm (q, 4H). 31P-NMR (CDCl₃, 121 MHz), δ=28.8 ppm.

### EXAMPLE 2

### Synthesis of (±)-[6,6′-bis(3,4-dihydro-2H-1,5-benzodioxepin)-7,7′-diyl]bis(diphenylphosphine oxide) (Hereinafter Referred to as (±)-bis-DBO)-coupling

18.4 ml (120 mmol) of diisopropylamine together with 95 ml of THF were placed in a 2 l four-neck flask provided with KPG stirrer, internal thermometer, dropping funnel and argon inlet under an argon atmosphere and 70 ml of n-butyllithium solution (1.6N in hexane, 106 mmol) were added at from −78 to −65° C. over a period of 60 minutes. After the addition was complete, the mixture was allowed to warm to −10° C. and was then cooled to −70° C. A solution of 35 g (100 mmol) of 3,4-dihydro-2H-1,5-benzodioxepin-7-diphenylphosphine oxide (DBO) in 880 ml of THF was added over a period of 4 hours while maintaining the temperature at −70° C. After the addition was complete, the mixture was allowed to warm to −40° C. over a period of 30 minutes and was subsequently cooled to −78° C., and a solution of 16.2 g (100 mmol) of iron(III) chloride in 140 ml of THF was added over a period of 30 minutes, with the temperature being kept below −65° C. After the addition was complete, the mixture was stirred at room temperature for 15 hours. After removal of the solvent under reduced pressure, the residue was taken up in 700 ml of methylene chloride and washed successively with 10% strength aqueous HCl (350 ml), water (350 ml) and saturated aqueous NaCl solution (350 ml). After drying over Na₂SO₄, the solvent was removed under reduced pressure and the residue was recrystallized from methylene chloride/ethyl acetate. This gave 17.1 g (25 mmol) of (±)-[6,6′-bis(3,4-dihydro-2H-1,5-benzodioxepin)-7,7′-diyl]bis(diphenylphosphine oxide) as a dirty-white solid.

Melting point: 259-261° C.

1H-NMR (CDCl₃, 500 MHz), δ=1.69 (m, 2H), 1.95 (m, 2H), 3.69 (m, 4H), 4.00 (m, 2H), 4.21 (m, 2H), 6.70-6.83 (m, 4H), 7.24-7.31 (m, 4H), 7.33-7.42 (m, 6H), 7.45 (m, 2H), 7.57 (dd, 7.6, 12.2 Hz, 4H), 7.62 ppm (dd, 7.6, 11.4 Hz, 4H).

31P-NMR (CDCl₃, 121 MHz), δ=29.4 ppm.

### EXAMPLE 3

### Racemate Resolution of (±)-[6,6′-bis(3,4-dihydro-2H-1,5-benzodioxepin)-7,7′-diyl]bis(diphenylphosphine oxide)—Preparation of (+)-bis-DBO and (−)-bis-DBO

A solution of 1.43 g (4 mmol) of (−)-dibenzoyltartaric acid in 25 ml of ethyl acetate was added while stirring to a refluxing solution of 5.59 g (8 mmol) of (±)-[6,6′-bis(3,4-dihydro-2H-1,5-benzodioxepin)-7,7′-diyl]bis-(diphenylphosphine oxide) in 50 ml of dichloromethane. After refluxing for two hours, the mixture was cooled to room temperature, the precipitate was separated off and dried under reduced pressure (weight: 2.55 g). The mother liquor was evaporated and treated separately (see below).

The precipitate which had been separated off (2.55 g) was taken up in 25 ml of dichloromethane, admixed with 15 ml of aqueous NaOH (2N) and stirred for 2 hours. After the aqueous phase had been separated off, the organic phase was washed with 2×20 ml of aqueous NaOH (2N) and subsequently with saturated NaCl solution, dried over Na₂SO₄ and the solvent was removed under reduced pressure. This gave 1.72 g of (−)-bis-DBO as a colorless solid:

[α]^{D}₂₀=−96.8° (c=1 g/100 ml of CHCl₃)

HPLC (hexane/isopropanol=92/8; flow rate: 1 ml/min): 99.8% ee (44.617 min), >98% chemical purity.

The evaporated mother liquor (4.54 g) was taken up in 40 ml of dichloromethane, admixed with 20 ml of aqueous NaOH (2N) and stirred for 1 hour. After the aqueous phase had been separated off, the organic phase was washed with 2×10 ml of aqueous NaOH (2N) and subsequently with saturated NaCl solution, dried over Na₂SO₄ and the solvent was removed under reduced pressure. This gave 4.31 g of solid which was dissolved in 40 ml of dichloromethane and, while heating under reflux, admixed with a solution of 1.43 g (4 mmol) of (+)-dibenzoyltartaric acid in 25 ml of ethyl acetate and the mixture was refluxed for 2 hours. After cooling the mixture to room temperature, the precipitate was separated off and dried under reduced pressure (weight: 3.42 g), taken up in 40 ml of dichloromethane, admixed with 20 ml of aqueous NaOH (2N) and the mixture was stirred for 1 hour. After the aqueous phase had been separated off, the organic phase was washed with 2×20 ml of aqueous NaOH (2N) and subsequently with saturated NaCl solution, dried over Na₂SO₄ and the solvent was removed under reduced pressure. This gave 2.21 g of (+)-bis-DBO as a colorless solid:

[α]^{D}₂₀=+96.8° (c=1 g/100 ml of CHCl₃)

HPLC (hexane/isopropanol=92/8; flow rate: 1 ml/min): 99.8% ee (35.424 min), >98% chemical purity.

### EXAMPLE 4

### Synthesis of (S)-(−)-[6,6′-bis(3,4-dihydro-2H-1,5-benzodioxepin)-7,7′-diyl]bis(diphenylphosphine) VIIa—Reduction

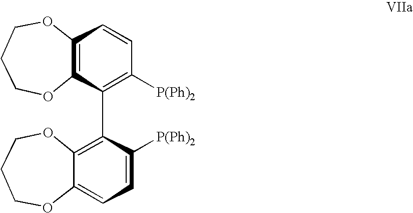

1.4 g (2 mmol) of (−)-[6,6′-bis(3,4-dihydro-2H-1,5-benzodioxepin)-7,7′-diyl]bis(diphenylphosphine oxide), 35 ml of toluene and 2.9 ml (21.9 mmol) of N,N-dimethylaniline were placed in a 100 ml three-neck flask provided with magnetic stirrer, reflux condenser, internal thermometer and dropping funnel and admixed with 2.1 ml (20 mmol) of trichlorosilane while stirring vigorously. After stirring for 8 hours at 100° C., the mixture was cooled and 25 ml of 4N aqueous NaOH were added carefully at 0° C. and the mixture was stirred at room temperature for 1 hour. The organic phase was separated off and the aqueous phase was extracted with toluene (2×20 ml). The combined organic phases were washed successively with 1N aqueous HCl (3×50 ml), water (50 ml) and saturated aqueous NaCl solution (50 ml), dried over Na₂SO₄ and the solvent was removed under reduced pressure, the residue was taken up in 50 ml of dichloromethane, the solution was evaporated under reduced pressure and the residue was recrystallized from dichloromethane/methanol. This gave 1.02 g of (−)-[6,6′-bis(3,4-dihydro-2H-1,5-benzodioxepin)-7,7′-diyl]bis(diphenylphosphine) (VIIa) as colorless needles.

Melting point: 247-249° C.

1H-NMR (CDCl₃, 500 MHz), δ=1.67 (m, 2H), 1.94 (m, 2H), 3.30 (m, 2H), 3.66-3.82 (m, 4H), 4.17 (m, 2H), 6.66 (d, 8.1 Hz, 2H), 6.87 (d, 8.1 Hz, 2H), 7.16-7.26 ppm (m, 20H).

31P-NMR (CDCl₃, 121 MHz), δ=−15.4 ppm.

[α]^{D}₂₀=−25.1° (c=1 g/100 ml of CHCl₃)

HPLC (Daicel “Chiracel OD-H”; hexane/isopropanol=98/2; flow rate: 0.5 ml/min; 40° C.): >99% ee (10.442 min), >99% chemical purity.

### EXAMPLE 5

### Synthesis of (R)-(+)-[6,6′-bis(3,4-dihydro-2H-1,5-benzodioxepin)-7,7′-diyl]bis(diphenylphosphine) VIIb

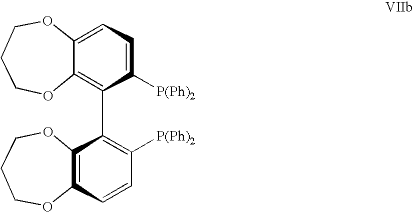

From 2.1 g of (+)-[6,6′-bis(3,4-dihydro-2H-1,5-benzodioxepin)-7,7′-diyl]bis(diphenylphosphine oxide) using a method analogous to Example 4. 1.41 g of (+)-[6,6′-bis(3,4-dihydro-2H-1,5-benzodioxepin)-7,7′-diyl]bis(diphenylphosphine) (VIIb) were obtained as a crystalline solid.

Melting point: 248-249° C.

1H-NMR (CDCl₃, 500 MHz), δ=1.67 (m, 2H), 1.94 (m, 2H), 3.30 (m, 2H), 3.66-3.82 (m, 4H), 4.17 (m, 2H), 6.66 (d, 8.1 Hz, 2H), 6.87 (d, 8.1 Hz, 2H), 7.16-7.26 ppm (m, 20H).

31P-NMR (CDCl₃, 121 MHz), δ=−15.4 ppm.

[α]^{D}₂=+25.1 (c=1 g/100 ml of CHCl₃)

HPLC (Daicel “Chiracel OD-H”; hexane/isopropanol=98/2; flow rate: 0.5 ml/min; 40° C.): >99% ee (9.200 min), >99% chemical purity.

### EXAMPLE 6

### Synthesis of [RuCl(p-cymene)(VIIa)]Cl

In a 50 ml Schlenk flask provided with magnetic stirrer and reflux condenser, 100 mg (0.15 mmol) of (−)-[6,6′-bis(3,4-dihydro-2H-1,5-benzodioxepin)-7,7′-diyl]bis(diphenylphosphine) (VIIa) were dissolved in 11 ml of methylene chloride under an argon atmosphere, admixed with 51 mg (0.083 mmol) of [{RuCl(p-cymene)}₂(μ-Cl)₂] and 4 ml of methanol and the mixture was stirred at 50° C. for 1 hour. The clear orange solution was subsequently evaporated under reduced pressure and the residue was dried in a high vacuum. This gave 143 mg (0.147 mmol) of the reddish brown Ru complex.

### EXAMPLE 7

### Synthesis of [RuCl(p-cymene)(VIIb)]Cl

The synthesis was carried out in a manner analogous to Example 6 using 100 mg (0.15 mmol) of (+)-[6,6′-bis(3,4-dihydro-2H-1,5-benzodioxepin)-7,7′-diyl]bis(diphenylphosphine) (VIIb). This gave 145 mg (0.149 mmol) of the Ru complex as a reddish brown solid.

### EXAMPLE 8

### Hydrogenation of methyl 3-oxopentanoate Using [RuCl(p-cymene)(VIIb)]Cl (S/C=2000)

A solution of 3.8 ml of methanol and 3 g (23 mmol) of methyl 3-oxopentanoate was degassed for 20 minutes under an argon atmosphere with ultrasonic treatment. After addition of 11.2 mg (0.0115 mmol) of [RuCl(p-cymene)(VIIb)]Cl and 0.55 mg (0.0058 mmol) of methanesulfonic acid, the solution was stirred vigorously at 100° C. under a hydrogen pressure of 10 bar in a steel autoclave with glass liner for 24 hours. After cooling to room temperature, the mixture was purified by distillation. This gave 3.04 g of methyl (R)-3-hydroxypentanoate.

99.9% ee (GC); >99 % chemical purity.

### EXAMPLE 9

### Hydrogenation of methyl 3-oxopentanoate Using [RuCl(p-cymene)(VIIa)]Cl (S/C=2000)

A solution of 3.8 ml of methanol and 3 g (23 mmol) of methyl 3-oxopentanoate was treated with [RuCl(p-cymene)(VIIa)]Cl in the manner described in Example 8. This gave 3.03 g of methyl (S)-3-hydroxypentanoate.

99.9% ee (GC); >99% chemical purity.

### EXAMPLE 10

### Synthesis of [RuCl(benzene)(VIIa)]Cl

In a 50 ml Schlenk flask provided with magnetic stirrer and reflux condenser, 100 mg (0.15 mmol) of VIIa were dissolved in 11 ml of methylene chloride under an argon atmosphere, admixed with 42 mg (0.083 mmol) of [{RuCl(benzene)}₂(μ-Cl)₂] and 4 ml of methanol and the mixture was stirred at 50° C. for 1 hour. The clear orange solution was subsequently evaporated under reduced pressure and the residue was dried in a high vacuum. This gave 143 mg (0.147 mmol) of the reddish brown Ru complex.

### EXAMPLE 11

### Hydrogenation of methyl 3-oxopentanoate Using [RuCl(benzene)(VIIa)]Cl (S/C=2000)

A solution of 3.8 ml of methanol and 3 g (23 mmol) of methyl 3-oxopentanoate was treated with 0.0115 mmol of [RuCl(benzene)(VIIa)]Cl in the manner described in Example 8. This gave 3.03 g of methyl (S)-3-hydroxy-pentanoate.

99.6 % ee (GC); >99 % chemical purity.

### EXAMPLE 12

### Synthesis of [RuBr₂(VIIa)]

4.7 mg (0.007 mmol) of VIIa and 2.4 mg (0.0075 mmol) of bis(methallyl)cyclooctadieneruthenium(II) together with 1 ml of acetone were placed in a 10 ml round-bottom flask provided with a magnetic stirrer under an argon atmosphere, admixed with 16 μl (0.014 mmol) of methanolic HBr solution (48% by weight) and the mixture was stirred at room temperature for 30 minutes. The brown solution was subsequently evaporated under reduced pressure and the residue was dried in a high vacuum. The reddish brown Ru compolex obtained in this way was subsequently used for hydrogenation.

### EXAMPLE 13

### Hydrogenation of methyl 3-oxopentanoate using [RuBr₂(VIIa)] (S/C=2000)

A solution of 3.8 ml of methanol and 3 g (23 mmol) of methyl 3-oxopentanoate was treated with 0.0115 mmol of [RuBr₂(VIIa)] in the manner described in Example 8. This gave 2.88 g of methyl (S)-3-hydroxypentanoate.

99.5% ee (GC); 95% chemical purity.

### EXAMPLE 14

### Asymmetric Michael Addition onto 2-cyclohexen-1-one

A mixture of 0.039 mmol of (S)-(−)-[6,6′-bis(3,4-dihydro-2H-1,5-benzodioxepin)-7,7′-diyl]bis(diphenylphosphine) (VIIa), 9.95 mg of Rh(acac)(C₂H₄)₂, 6.42 mmol of phenylboronic acid, 4 ml of dioxane, 0.4 ml of water and 1.3 mmol of 2-cyclohexen-1-one was stirred at 100° C. under an argon atmosphere for 6 hours. After cooling to room temperature, the mixture was evaporated under reduced pressure, the residue was taken up in 50 ml of ethyl acetate and the organic phase was washed with 20 ml of saturated aqueous sodium hydrogencarbonate solution and dried over magnesium sulfate. After removal of the solvent under reduced pressure, the residue was purified on silica gel.

This gave (S)-3-phenylcyclohexanone having an optical purity of 97.4% ee.

### EXAMPLE 15

### Asymmetric Isomerization of diethylgeranylamine

A solution of 0.025 mmol of [Rh(VIIb)(COD)]ClO₄ in 5 ml of tetrahydrofuran was stirred under a hydrogen atmosphere at 1 bar for 20 minutes at room temperature. 0.52 g (2.5 mmol) of (E)-trans-N,N-diethyl-3,7-dimethyl-2,6-octadienylamine was subsequently added and the mixture was stirred at 40° C. under an argon atmosphere for 24 hours. After removal of the solvent under reduced pressure, the residue was purified by bulb tube distillation.

This gave (3S)-trans-N,N-diethyl-3,7-dimethyl-1,6-octadienylamine having an optical purity of 96.8% ee.

### EXAMPLE 16

### Synthesis of 3,3,4,4-tetrafluoro[2,5H]-1,6-benzodioxocin

31.2 g of catechol and 39.6 g of potassium hydroxide together with 800 ml of acetonitrile were placed in a 2 l three-neck flask provided with magnetic stirrer and reflux condenser and the mixture was heated to 75° C. while stirring. After dropwise addition of 120 g of 2,2,3,3-tetrafluoro-1,4-bis(trifluoromethanesulfonate)butane in 500 ml of acetonitrile, the mixture was allowed to cool to 25° C. and was stirred for another 3 hours. After filtration and removal of the solvent under reduced pressure, the residue was taken up in 300 ml of MTBE, washed with 1N aqueous HCl (200 ml) and saturated aqueous NaCl (200 ml), dried over sodium sulfate and the solvent was removed under reduced pressure. The residue was purified on silica gel (eluent: petroleum ether/ethyl acetate 8/1). This gave 48 g of 3,3,4,4-tetrafluoro[2,5H]-1,6-benzodioxocin as colorless crystals.

### EXAMPLE 17

### Synthesis of 8-bromo-3,3,4,4-tetrafluoro[2,5H]-1,6-benzodioxocin

102 g of bromine dissolved in 100 ml of glacial acetic acid were slowly added dropwise to a mixture of 500 ml of glacial acetic acid, 30 g of potassium bromide and 30 g of 3,3,4,4-tetrafluoro[2,5H]-1,6-benzodioxocin while stirring at 110° C. Heating was subsequently interrupted and the mixture was stirred overnight at room temperature. After addition of 500 ml of water, the mixture was extracted with dichloromethane (3×300 ml) and the combined organic extracts were washed with 1N aqueous sodium thiosulfate solution (250 ml) and subsequently with saturated aqueous sodium carbonate solution (250 ml) and water. Drying (sodium sulfate) and removal of the solvent gave a yellowish brown oil. Purification by distillation gave 34 g of 8-bromo-3,3,4,4-tetrafluoro[2,5H]-1,6-benzodioxocin.

### EXAMPLE 18

### Synthesis of diphenyl(3,3,4,4-tetrafluoro[2,5H]-1,6-benzodioxocin-8-yl)phosphine oxide

2 g (83 mmol) of magnesium turnings together with 100 ml of tetrahydrofuran (THF) were placed in a 250 ml three-neck flask provided with magnetic stirrer, reflux condenser, internal thermometer and dropping funnel under an argon atmosphere. While stirring, a solution of 25 g (80 mmol) of 8-bromo-3,3,4,4-tetrafluoro[2,5H]-1,6-benzodioxocin in 10 ml of THF was added dropwise over a period of 20 minutes and the mixture was refluxed for 5 hours. After cooling to 0° C., 13 ml (68 mmol) of diphenylphosphinyl chloride were added dropwise over a period of 20 minutes, with the temperature being kept below 10° C. The mxiture was subsequently stirred overnight at room temperature.

At about 10° C., firstly 20 ml of water and then 25 ml of 1N HCl were added slowly and the mixture was subsequently stirred for 90 minutes. After dilution with 80 ml of water, the solution was extracted with methylene chloride (3×70 ml), the organic phases were combined and washed successively with 1N HCl (80 ml), saturated aqueous NaHCO₃ solution (80 ml), water (80 ml) and saturated aqueous NaCl solution (80 ml). After drying over Na₂SO₄, the solvent was removed under reduced pressure. Recrystallization from 100 ml of toluene gave 26 g (60 mmol) of diphenyl(3,3,4,4-tetrafluoro[2,5H]-1,6-benzodioxocin-8-yl)phosphine oxide.

### EXAMPLE 19

### Synthesis of (±)-[7,7′-bis(3,3,4,4-tetrafluoro[2,5H]-1,6-benzodioxocin)-8,8′-diyl]bis(diphenylphosphine oxide) (hereinafter referred to as (±)-bis-F4-DBO)—coupling

9.2 ml (60 mmol) of diisopropylamine together with 50 ml of THF were placed in a 1 l four-neck flask provided with KPG stirrer, internal thermometer, dropping funnel and argon inlet under an argon atmosphere and 35 ml of n-butyllithium solution (1.6N in hexane, 53 mmol) were added at from −78 to −65° C. over a period of 30 minutes. After the addition was complete, the mixture was allowed to warm to −10° C. and was then cooled to −70° C. A solution of 22 g (50 mmol) of diphenyl(3,3,4,4-tetrafluoro[2,5H]-1,6-benzodioxocin-8-yl)phosphine oxide in 400 ml of THF was added over a period of 2 hours while maintaining the temperature at −70° C. After the addition was complete, the mixture was allowed to warm to −40° C. over a period of 20 minutes and was subsequently cooled to −78° C. and a solution of 8.1 g (50 mmol) of iron(III) chloride in 70 ml of THF was added over a period of 20 minutes while keeping the temperature below −65° C. After the addition was complete, the mixture was stirred at room temperature for 18 hours. After removal of the solvent under reduced pressure, the residue was taken up in 300 ml of methylene chloride and washed successively with 10% strength aqueous HCl (200 ml), water (200 ml) and saturated aqueous NaCl solution (200 ml). After drying over Na₂SO₄, the solvent was removed under reduced pressure and the residue was recrystallized from methylene chloride/ethyl acetate. This gave 10.4 g (12 mmol) of (±)-[7,7′-bis(3,3,4,4-tetrafluoro[2,5H]-1,6-benzodioxocin)-8,8′-diyl]bis(diphenylphosphine oxide) as a dirty-white solid.

### EXAMPLE 20

### Racemate resolution of (±)-[7,7′-bis(3,3,4,4-tetrafluoro[2,5H]-1,6-benzodioxocin)-8,8′-diyl]bis(diphenylphosphine oxide)—preparation of (+)-bis-F4-DBO and (−)-bis-F4-DBO

A solution of 2.86 g (8 mmol) of (−)-dibenzoyltartaric acid in 45 ml of ethyl acetate was added while stirring to a refluxing solution of 6.96 g (8 mmol) of (±)-[7,7′-bis(3,3,4,4-tetrafluoro[2,5H]-1,6-benzodioxocin)-8,8′-diyl]bis(diphenylphosphine oxide) in 60 ml of dichloromethane. After heating under reflux for 2 hours, the mixture was cooled to room temperature, the precipitate was separated off and dried under reduced pressure. The mother liquor was evaporated and treated separately (see below).

The precipitate which had been separated off was taken up in 30 ml of dichloromethane, admixed with 30 ml of aqueous NaOH (2N) and stirred for 2 hours. After the aqueous phase had been separated off, the organic phase was washed with 2×20 ml of aqueous NaOH (2N) and subsequently with saturated aqueous NaCl solution, dried over Na₂SO₄ and the solvent was removed under reduced pressure. This gave 3.13 g of (−)-bis-F4-DBO as a colorless solid.

The evaporated mother liquor was taken up in 50 ml of dichloromethane, admixed with 30 ml of aqueous NaOH (2N) and stirred for 1 hour. After the aqueous phase had been separated off, the organic phase was washed with 2×20 ml of aqueous NaOH (2N) and subsequently with saturated aqueous NaCl solution, dried over Na₂SO₄ and the solvent was removed under reduced pressure. This gave a solid which was dissolved in 50 ml of dichloromethane and, while heating under reflux, admixed with a solution of 2.86 g (8 mmol) of (+)-dibenzoyltartaric acid in 45 ml of ethyl acetate and the mixture was refluxed for 2 hours. After cooling the mixture to room temperature, the precipitate was separated off and dried under reduced pressure, taken up in 60 ml of dichloromethane, admixed with 30 ml of aqueous NaOH (2N) and the mixture was stirred for 1 hour. After the aqueous phase had been separated off, the organic phase was washed with 2×30 ml of aqueous NaOH (2N) and subsequently with saturated aqueous NaCl solution, dried over Na₂SO₄ and the solvent was removed under reduced pressure. This gave 3.21 g of (+)-bis-F4-DBO as a colorless solid.

### EXAMPLE 21

### Synthesis of (S)-(−)-[7,7′-bis(3,3,4,4-tetrafluoro[2,5H]-1,6-benzodioxocin)-8,8′-diyl]bis(diphenylphosphine)—reduction

2.6 g (3 mmol) of (−)-[7,7′-bis(3,3,4,4-tetrafluoro[2,5H]-1,6-benzodioxocin)-8,8′-diyl]bis(diphenylphosphine oxide), 50 ml of toluene and 4.4 ml (33 mmol) of N,N-dimethylaniline were placed in a 250 ml three-neck flask provided with magnetic stirrer, reflux condenser, internal thermometer and dropping funnel and 3.2 ml (30 mmol) of trichlorosilane were added while stirring vigorously. After stirring at 100° C. for 8 hours, the mixture was cooled and 40 ml of 4N aqueous NaOH were added carefully at 0° C. and the mixture was stirred at room temperature for 1 hour. The organic phase was separated off and the aqueous phase was extracted with toluene (2×30 ml). The combined organic phases were washed successively with 1N aqueous HCl (3×70 ml), water (70 ml) and saturated aqueous NaCl solution (70 ml) and dried over Na₂SO₄ and the solvent was removed under reduced pressure, the residue was taken up in 70 ml of dichloromethane, evaporated under reduced pressure and recrystallized from dichloromethane/methanol. This gave 2.14 g of (−)-[7,7′-bis(3,3,4,4-tetrafluoro[2,5H]-1,6-benzodioxocin)-8,8′-diyl]bis(diphenyl-phosphine) as colorless needles.

### EXAMPLE 22

### Synthesis of (R)-(+)-[7,7′-bis(3,3,4,4-tetrafluoro[2,5H]-1,6-benzodioxocin)-8,8′-diyl]bis(diphenylphosphine)—reduction

From 2.4 g of (+)-[7,7′-bis(3,3,4,4-tetrafluoro[2,5H]-1,6-benzodioxocin)-8,8′-diyl]bis(diphenylphosphine oxide) in a manner analogous to Example 21. This gave 1.98 g of (R)-(+)-[7,7′-bis(3,3,4,4-tetrafluoro[2,5H]-1,6-benzodioxocin)-8,8′-diyl]bis(diphenylphosphine) as a crystalline solid.

### EXAMPLE 23

### Synthesis of [RuCl(p-cymene)((−)-[7,7′-bis(3,3,4,4-tetrafluoro[2,5H]-1,6-benzodioxocin)-8,8′-diyl]bis(diphenylphosphine))]Cl

In a 50 ml Schlenk flask provided with magnetic stirrer and reflux condenser, 126 mg (0.15 mmol) of (−)-[7,7′-bis(3,3,4,4-tetrafluoro[2,5H]-1,6-benzodioxocin)-8,8′-diyl]bis(diphenylphosphine) were dissolved in 15 ml of methylene chloride under an argon atmosphere, admixed with 51 mg (0.083 mmol) of [{RuCl(p-cymene)}₂(μ-Cl)₂] and 6 ml of methanol and the mixture was stirred at 50° C. for one hour. The solution was subsequently evaporated under reduced pressure and the residue was dried in a high vacuum. This gave 168 mg (0.147 mmol) of the reddish brown Ru complex.

### EXAMPLE 24

### Synthesis of [RuCl(p-cymene)((+)-[7,7′-bis(3,3,4,4-tetrafluoro-[2,5H]-1,6-benzodioxocin)-8,8′-diyl]bis(diphenylphosphine))]Cl

The synthesis was carried out in a manner analogous to Example 23 using 126 mg (0.15 mmol) of (+)-[7,7′-bis(3,3,4,4-tetrafluoro[2,5H]-1,6-benzodioxocin)-8,8′-diyl]bis(diphenylphosphine). This gave 170 mg (0.149 mmol) of the Ru complex as a reddish brown solid.

### EXAMPLE 25

### Hydrogenation of methyl 3-oxopentanoate Using [RuCl(p-cymene)((+)-[7,7′-bis(3,3,4,4-tetrafluoro[2,5H]-1,6-benzodioxocin)-8,8′-diyl]bis(diphenylphosphine))]Cl (S/C ═2000)

A solution of 3.8 ml of methanol and 3 g (23 mmol) of methyl 3-oxopentanoate was degassed for 20 minutes under an argon atmosphere with ultrasonic treatment. After addition of 13.2 mg (0.0115 mmol) of [RuCl(p-cymene)((+)-[7,7′-bis(3,3,4,4-tetrafluoro[2,5H]-1,6-benzodioxocin)-8,8′-diyl]bis(diphenylphosphine))]Cl and 0.55 mg (0.0058 mmol) of methanesulfonic acid, the solution was stirred vigorously at 100° C. under a hydrogen pressure of 10 bar in a steel autoclave provided with a glass liner for 24 hours. After cooling to room temperature, the mixture was purified by distillation. This gave 3.02 g of methyl(R)-3-hydroxypentanoate.

>97% ee (GC); >97% chemical purity.

1. A compound of the formula (I) 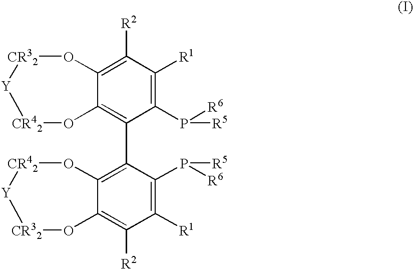
wherein
R¹ and R² are each hydrogen,
R³ and R⁴ are identical or different and are independently selected from the group consisting of hydrogen, fluorine, C₁-C₁₀-alkyl, and CF₃,
Y is a divalent radical selected from the group consisting of CR⁹₂, CHR⁹, (cis)-CH═CH, CR⁹₂CR¹⁰₂, CHR⁹CHR¹⁰, 1,2-arylene, CHR⁹-O-CHR¹⁰, and CR⁹₂—O—CR¹⁰₂,
where R⁹ and R¹⁰ are identical or different and are independently selected from the group consisting of hydrogen; Q; monosubstituted, polysubstituted or unsubstituted C₁-C₁₀-alkyl, C₃-C₁₀-cycloalkyl, C₂-C₁₀-alkenyl, C₄-C₁₀-cycloalkenyl, C₂-C₁₀-alkynyl, C₆-C₁₅-aryl, and C₁-C₁₅-heteroaryl, where the substituents are optionally Q and
Q is selected from the group consisting of —F, —Cl, —Br, —I, —CN, —NO₂, —NR⁷R⁸, —NR⁷OR⁸, —OR⁷, —C(O)R⁷, SR⁷, —SO₃R⁷, —C(O)OR⁷, —C(O)NR⁷R⁸, —OC(O)R⁷, and —NR⁷C(O)R⁸,
R⁷ and R⁸ are identical or different and are independently selected from R⁹,
R⁵ and R⁶ are identical or different and are independently selected from the group consisting of monosubstituted, polysubstituted or unsubstituted C₃-C₁₀-cycloalkyls, C₄-C₁₀-cycloalkenyls, C₅-C₁₅-aryls and C₁-C₁₅-heteroaryls, where the substituents are optionally Q.

2. The compound of claim 1 in an optical configuration of the formulae (Ia) and (Ib)

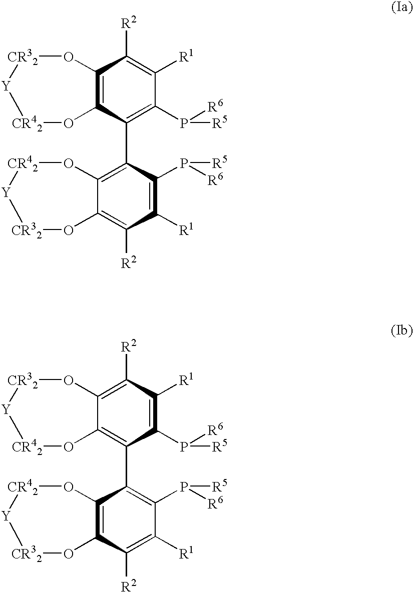

3. A process for preparing a compound of claim 1, comprising the steps:
A) reacting a compound of the formula (IV) 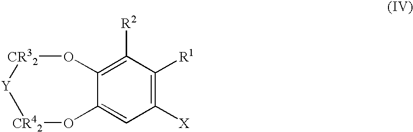
where X is halogen,
with a phosphinyl chloride R⁵R⁶P(O)Cl, to form a compound of the formula (IIIa) 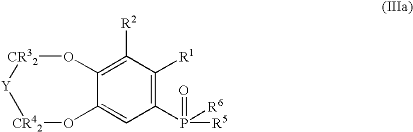
B) converting the compound of the formula (IIIa) obtained in step A into a compound of the general formula (II) 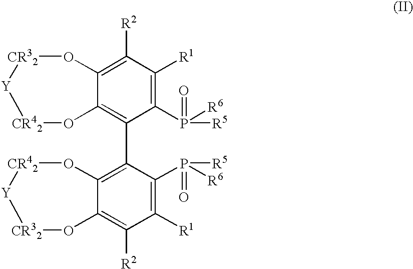
by oxidative coupling and
C) reducing the compound of the formula (II) obtained in step B.

4. The process of claim 3, wherein, in step B, the compound of the general formula (IIIa) obtained from step A is firstly converted by iodination into an intermediate of the formula (IIIb) 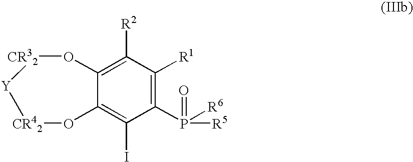
and this intermediate is subsequently converted in a metal-catalyzed coupling reaction into a compound of the formula (II).

5. The process of claim 3, wherein the compounds of the formula (II) obtained in step B are prepared in enantiomerically pure or enantiomerically enriched form corresponding to the general formulae (IIa) and (IIb) 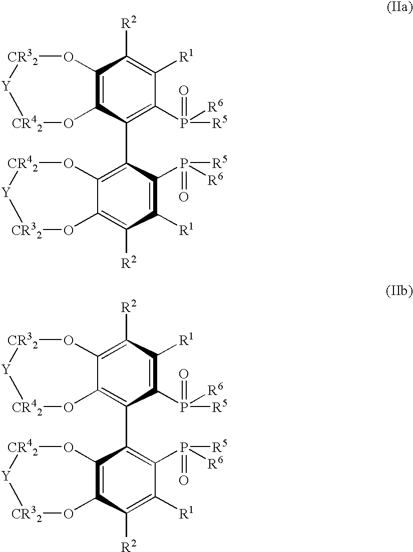
by fractional crystallization in the presence of complexing chiral compounds.

6. The process of claim 4, wherein the compounds of the formula (II) obtained in step B are prepared in enantiomerically pure or enantiomerically enriched form corresponding to the general formulae (IIa) and (IIb) 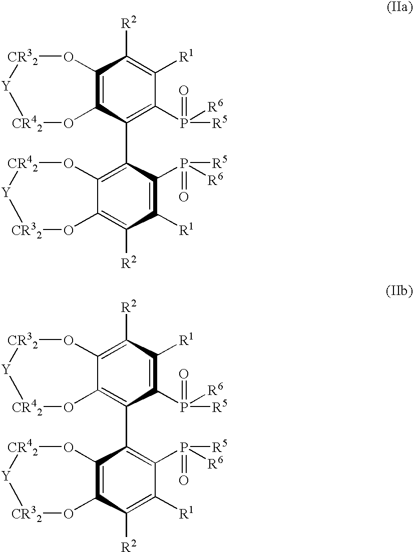
by fractional crystallization in the presence of complexing chiral compounds.

7. The process of claim 3, wherein the compounds of the formula (I) are prepared in enantiomerically pure or enantiomerically enriched form corresponding to the formulae (Ia) and (Ib) by converting to a chiral palladium complex in an additional step D.

8. The process of claim 4, wherein the compounds of the formula (I) are prepared in enantiomerically pure or enantiomerically enriched form corresponding to the formulae (Ia) and (Ib) by converting to a chiral palladium complex in an additional step D.

9. A compound of the formula (II) 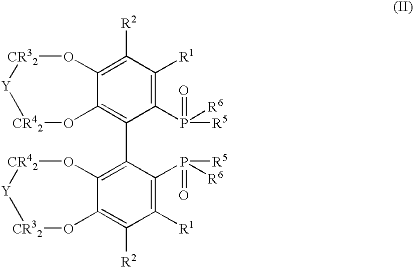
wherein
R¹ and R² are each hydrogen,
R³ and R⁴ are identical or different and are independently selected from the group consisting of hydrogen, fluorine, C₁-C₁₀-alkyl, and CF₃,
Y is a divalent radical selected from the group consisting of CR⁹₂, CHR⁹, (cis)-CH═CH, CR⁹₂CR¹⁰₂, CHR⁹CHR¹⁰, 1,2-arylene, CHR⁹—O—CHR¹⁰, and CR⁹₂—O—CR¹⁰₂,
where R⁹ and R¹⁰ are identical or different and are independently selected from the group consisting of hydrogen; Q; monosubstituted, polysubstituted or unsubstituted C₁-C₁₀-alkyl, C₃-C₁₀-cycloalkyl, C₂-C₁₀-alkenyl, C₄-C₁₀-cycloalkenyl, C₂-C₁₀-alkynyl, C₆-C₁₅-aryl, and C₁-C₁₅-heteroaryl, where the substituents are optionally Q and
Q is selected from the group consisting of —F, —Cl, —Br, —I, —CN, —NO₂, —NR⁷R⁸, —NR⁷OR⁸, —OR⁷, —C(O)R⁷, SR⁷, —SO₃R⁷, —C(O)OR⁷, —C(O)NR⁷R⁸, —OC(O)R⁷, and —NR⁷C(O)R⁸,
R⁷ and R⁸ are identical or different and are independently selected from R⁹,
R⁵ and R⁶ are identical or different and are independently selected from the group consisting of monosubstituted, polysubstituted or unsubstituted C₃-C₁₀-cycloalkyls, C₄-C₁₀-cycloalkenyls, C₅-C₁₅-aryls and C₁-C₁₅-heteroaryls, where the substituents are optionally Q.

10. A compound of claim 9 in an optical configuration of the formulae (IIa) and (IIb)

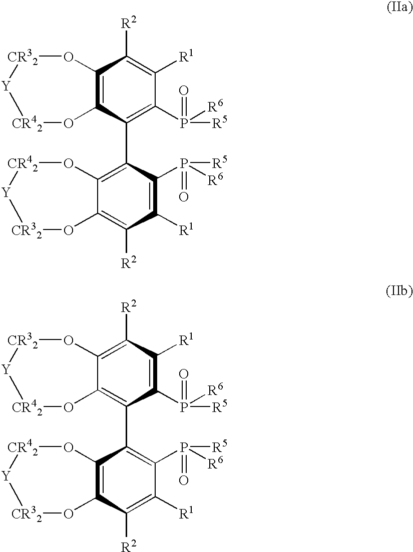

11. A process for preparing enantiomerically pure or enantiomerically enriched compounds of claim 10 by fractional crystallization of compounds of the formula II in the presence of at least one complexing chiral compound.

12. A process for preparing enantiomerically pure or enantiomerically enriched compounds of claim 2 by converting compounds of the formula I into chiral palladium complexes.

13. A compound of the formula (IIIa) or (IIIb) 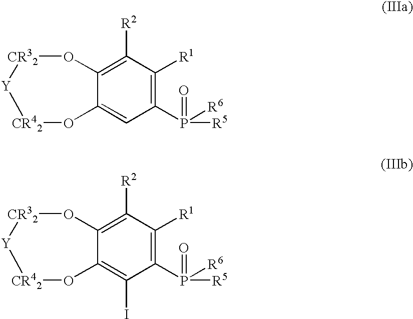
wherein
R¹ and R² are each hydrogen,
R³ and R⁴ are identical or different and are independently selected from the group consisting of hydrogen, fluorine, C₁-C₁₀-alkyl, and CF₃,
Y is a divalent radical selected from the group consisting of CR⁹², CHR⁹, (cis)-CH═CH, CR⁹₂CR¹⁰₂, CHR⁹CHR¹⁰, 1,2-arylene, CHR⁹—O—CHR¹⁰, and CR⁹₂—O—CR¹⁰_{2,}
where R⁹ and R¹⁰ are identical or different and are independently selected from the group consisting of hydrogen; Q; monosubstituted, polysubstituted or unsubstituted C₁-C₁₀-alkyl, C₃-C₁₀-cycloalkyl, C₂-C₁₀-alkenyl, C₄-C₁₀-cycloalkenyl, C₂-C₁₀-alkynyl, C6-C₁₅-aryl, and C₁-C₁₅-heteroaryl, where the substituents are optionally Q and
Q is selected from the group consisting of —F, —Cl, —Br, —I, —CN, —NO₂, —NR⁷R⁸, —NR⁷OR⁸, —OR⁷, —C(O)R⁷, SR⁷, —SO₃R⁷, —C(O)OR⁷, —C(O)NR⁷R⁸, —OC(O)R⁷, and —NR⁷C(O)R⁸,
R⁷ and R⁸ are identical or different and are independently selected from R⁹,
R⁵ and R⁶ are identical or different and are independently selected from the group consisting of monosubstituted, polysubstituted or unsubstituted C₃-C₁₀-cycloalkyls, C₄-C₁₀-cycloalkenyls, C₅-C₁₅-aryls and C₁-C₁₅-heteroaryls, where the substituents are optionally Q.

14. A compound of the formula (IV) 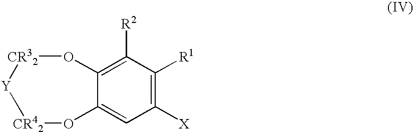
where
R¹ and R² are each hydrogen,
R³ and R⁴ are identical or different and are independently selected from the group consisting of hydrogen, fluorine, C₁-C₁₀-alkyl, and CF₃,
R⁷ and R⁸ are identical or different and are independently selected from R⁹,
Y is a divalent radical selected from the group consisting of CR⁹₂, CHR⁹, (cis)-CH═CH, CR⁹₂CR¹⁰₂, CHR⁹CHR¹⁰, 1,2-arylene, CHR⁹—O—CHR¹⁰, and CR⁹₂—O—CR¹⁰₂,
where R⁹ and R¹⁰ are identical or different and are independently selected from the group consisting of hydrogen; Q; monosubstituted, polysubstituted or unsubstituted C₁-C₁₀-alkyl, C₃-C₁₀-cycloalkyl, C₂-C₁₀-alkenyl, C₄-C₁₀-cycloalkenyl, C₂-C₁₀-alkynyl, C₆-C₁₅-aryl, and C₁-C₁₅-heteroaryl, where the substituents are optionally Q,
Q is selected from the group consisting of —F, —Cl, —Br, —I, —CN, —NO₂, —NR⁷R⁸, —NR⁷OR⁸, —OR⁷, —C(O)R⁷, SR⁷, —SO₃R⁷, —C(O)OR⁷, —C(O)NR⁷R⁸, —OC(O)R⁷, and —NR⁷C(O)R⁸,
with the proviso that CR³₂—Y—CR⁴₂ cannot be (CH₂)₃ when X is Br.

15. A complex comprising at least one ligand of formula (I) of claim 1, and at least one metallic center.

16. The complex of claim 15, wherein at least one ligand of formula (I) is present in enantiomerically pure or enantiomerically enriched form.

17. The complex of claim 15, wherein, when a ligand of the general formula (I) which is not enantiomerically pure is present, another chiral ligand is additionally present.

18. The complex of claim 15, wherein the metallic center is selected from the group consisting of rhodium, ruthenium, iridium, palladium, copper and nickel.

19. The complex of claim 17, wherein the metallic center is selected from the group consisting of rhodium, ruthenium, iridium, palladium, copper and nickel.

20. A process for preparing a complex of claim 15, comprising reacting a compound of the formula (I) with a precursor containing the metallic center, in the presence of an organic solvent.

21. In an orgnic synthesis wherein a metal complex catalyst is employed, the improvement comprising selecting as a catalyst, a complex of claim 15.

22. The synthesis of claim 21, wherein a chiral complex is used as the catalyst in an asymmetric organic synthesis.

23. The synthesis of claim 21 wherein the catalyst is a homogeneous catalyst or is present in immobilized form as a heterogeneous catalyst.

24. The synthesis of claim 21 which is a hydrogenation, isomerization, or C—C bond formation reaction.

25. A process for hydrogenating C═O, C═C or C═N groups in a substrate, comprising hydrogenating in the presence of a complex of claim 15.

26. The process claim 25, wherein said process is an asymmetric hydrogenation carried out in the presence of a chiral complex of Formula I.

27. The process of claim 26, wherein hydrogenation is carried out in the presence of a complex containing (S)-(−)-[6,6′-bis(3,4-dihydro-2H-1,5-benzodioxepin)-7,7′-diyl]bis(diphenylphosphine) (VIIa) 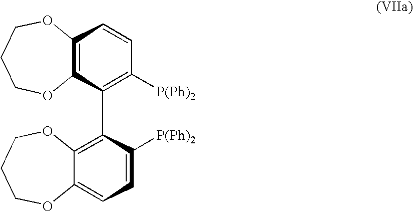
or (R)-(+)-[6,6′-bis(3,4-dihydro-2H-1,5-benzodioxepin)-7,7′-diyl]bis(diphenylphosphine) (VIIb) 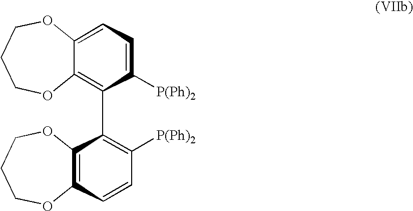
as a ligand.
